(19) United States
(12) Patent Application Publication
(10) Pub. No.: US 2026/0281170 A1
(43) Pub. Date: Sep. 17, 2026

(54) VOICE OVER INTERNET PROTOCOL (VoIP) TRANSMIT REDUNDANCY

(71) Applicant: QUALCOMM Incorporated, San Diego, CA (US)

(72) Inventors: Anandbabu MUSUATHY SADASIVAN, San Diego, CA (US); Vikram SINGH, San Diego, CA (US)

(21) Appl. No.: 19/079,324

(22) Filed: Mar. 13, 2025

(51) Int. Cl. H04L 65/65; H04L 65/1069; H04M 7/00

(52) U.S. Cl. CPC H04L 65/65; H04L 65/1069; H04M 7/006

(57) ABSTRACT

A method for of wireless communication includes establishing a primary real-time transport protocol (RTP) link to a peer device via an Internet protocol-based multimedia subsystem (IMS) network. The method also includes establishing a duplicate real-time transport protocol (RTP) link to the peer device via a firewall and a network address translation (NAT) server. The duplicate RTP link is initially established with a session traversal utilities for NAT (STUN) server. The method further includes transmitting RTP packets to the peer device via the primary RTP link and the duplicate RTP link. The method still further includes determining whether to continue with the duplicate RTP link established with the STUN server or to reestablish the duplicate RTP link with a traversal using relays around NAT (TURN) server.

### FIELD OF THE DISCLOSURE

The present disclosure relates generally to wireless communications, and more specifically to bandwidth efficient and cost effective voice over Internet protocol (VoIP) transmit redundancy.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method for of wireless communication includes establishing a primary real-time transport protocol (RTP) link to a peer device via an Internet protocol-based multimedia subsystem (IMS) network. The method also includes establishing a duplicate real-time transport protocol (RTP) link to the peer device via a firewall and a network address translation (NAT) server. The duplicate RTP link is initially established with a session traversal utilities for NAT (STUN) server. The method further includes transmitting RTP packets to the peer device via the primary RTP link and the duplicate RTP link. The method still further includes determining whether to continue with the duplicate RTP link established with the STUN server or to reestablish the duplicate RTP link with a traversal using relays around NAT (TURN) server.

Other aspects of the present disclosure are directed to an apparatus. The apparatus has one or more memories and one or more processors coupled to the one or more memories. The processor(s) is configured to establish a primary real-time transport protocol (RTP) link to a peer device via an Internet protocol-based multimedia subsystem (IMS) network. The processor(s) is also configured to establish a duplicate real-time transport protocol (RTP) link to the peer device via a firewall and a network address translation (NAT) server. The duplicate RTP link is initially established with a session traversal utilities for NAT (STUN) server. The processor(s) is further configured to transmit RTP packets to the peer device via the primary RTP link and the duplicate RTP link. The processor(s) is still further configured to determine whether to continue with the duplicate RTP link established with the STUN server or to reestablish the duplicate RTP link with a traversal using relays around NAT (TURN) server.

In other aspects of the present disclosure, a non-transitory computer-readable medium with program code recorded thereon is disclosed. The program code is executed by a processor and includes program code to establish a primary real-time transport protocol (RTP) link to a peer device via an Internet protocol-based multimedia subsystem (IMS) network. The program code also includes program code to establish a duplicate real-time transport protocol (RTP) link to the peer device via a firewall and a network address translation (NAT) server. The duplicate RTP link is initially established with a session traversal utilities for NAT (STUN) server. The program code further includes program code to transmit RTP packets to the peer device via the primary RTP link and the duplicate RTP link. The program code still further includes program code to determine whether to continue with the duplicate RTP link established with the STUN server or to reestablish the duplicate RTP link with a traversal using relays around NAT (TURN) server.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a diagram illustrating primary and duplicate real-time transport protocol (RTP) streams, in accordance with various aspects of the present disclosure.

FIG. 5 is a diagram illustrating network address translation (NAT), in accordance with various aspects of the present disclosure.

FIGS. 6-9 are diagrams illustrating various types of network address translation (NAT), in accordance with various aspects of the present disclosure.

FIG. 10 is a diagram illustrating operation with a session traversal utilities for NAT (STUN) server, in accordance with various aspects of the present disclosure.

FIG. 11 is a block diagram illustrating peer-to-peer communications with a STUN server in a cone NAT configuration, in accordance with various aspects of the present disclosure.

FIG. 12 is a block diagram illustrating peer-to-peer communications with a STUN server in a symmetric NAT configuration, in accordance with various aspects of the present disclosure.

FIG. 13 is a diagram illustrating a traversal using relays around NAT (TURN) server, in accordance with various aspects of the present disclosure.

FIG. 14 is a table illustrating example operations of a TURN server.

FIG. 15 is a diagram illustrating a dual TURN server configuration, in accordance with various aspects of the present disclosure.

FIGS. 16A and 16B show a call flow diagram illustrating STUN/TURN server determination, in accordance with various aspects of the present disclosure.

FIGS. 17A and 17B show a call flow diagram illustrating an alternative technique for STUN/TURN server determination, in accordance with various aspects of the present disclosure.

FIG. 18 is a flow diagram illustrating an example process performed, for example, by a user equipment (UE), in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Real-time transport protocol (RTP) enables users to place audio and video calls over an Internet protocol (IP) network. Because a cellular network may provide poor connectivity, a wireless local area network (WLAN), such as WIFI, may be used to carry a secondary stream (also referred to as a duplicate or redundant stream/link). A receiver improves the quality of the transmitted voice and/or video data by receiving and merging the primary and duplicate streams.

Because a redundant link is over the Internet, network address translation (NAT) configurations and firewalls may block peer-to-peer (P2P) communications. Thus, a traversal using relays around NAT (TURN) server may be employed to relay between user equipment (UEs) and penetrate the target UE's NAT interface and firewalls. TURN server usage comes with a pecuniary cost as the data is relayed, and also a latency cost for the packet flow. It would be desirable to control the TURN server usage and reduce the costs associated with using the TURN server.

Aspects of the present disclosure reduce the overall cost of the redundancy solution using a mix of session traversal utilities for NAT (STUN) based and TURN-based redundancy. The proposed approach is a bandwidth efficient solution for voice over Internet protocol (VoIP) redundancy using compact binary coded redundancy statistics data exchanged between devices leveraging an existing Internet protocol (IP)-based multimedia subsystem (IMS) packet data network (PDN) connection between UEs on a call.

According to aspects of the present disclosure, with STUN/TURN-based redundancy, each end shares its redundancy link statistics with the other end via real-time control protocol (RTCP) source description (SDES). STUN-based redundancy starts between user equipment (UEs) in the call. If the transmitter UE sees that the transmitter had sent redundant packets to the peer and the peer report states that the receiver had received zero redundant packets, then the UE(s) may be inside a symmetric network address translation (NAT) network. Thus, a TURN-based redundancy channel is established between the UEs. Otherwise, the STUN-based solution is acceptable, saving cost. Accordingly, a TURN server is not used for the call.

Another technique for selecting between STUN and TURN-based P2P IMS media redundancy is to query the sequence numbers (SNs) received by the peer on the redundant link using RTCP SDES sent over the primary link on the IMS packet data network (PDN). In these aspects, STUN-based redundancy is started between UEs in the call. The local UE sends an RTCP SDES query over the primary link to obtain a highest sequence number received by the peer on the redundant link. The remote UE sends an RTCP SDES response with the highest sequence number received on the redundant link. If the STUN-based solution works, cost savings are achieved and additional latency is avoided. Otherwise, if the remote UE response indicates an invalid sequence number, then UEs may be inside a symmetric NAT network. Thus, a TURN-based redundancy channel is established between the UEs.

Particular aspects of the subject matter described in this disclosure can be implemented to realize one or more of the following potential advantages. In some examples, the described techniques, such as real-time transport protocol (RTP) transmit redundancy may increase reliability, reduce latency, and lower costs. Although the current description is with respect to voice communications, video frames may also be sent over the redundancy link. Because video frames require significantly more bandwidth than audio frames, the cost savings is even more substantial for video communications.

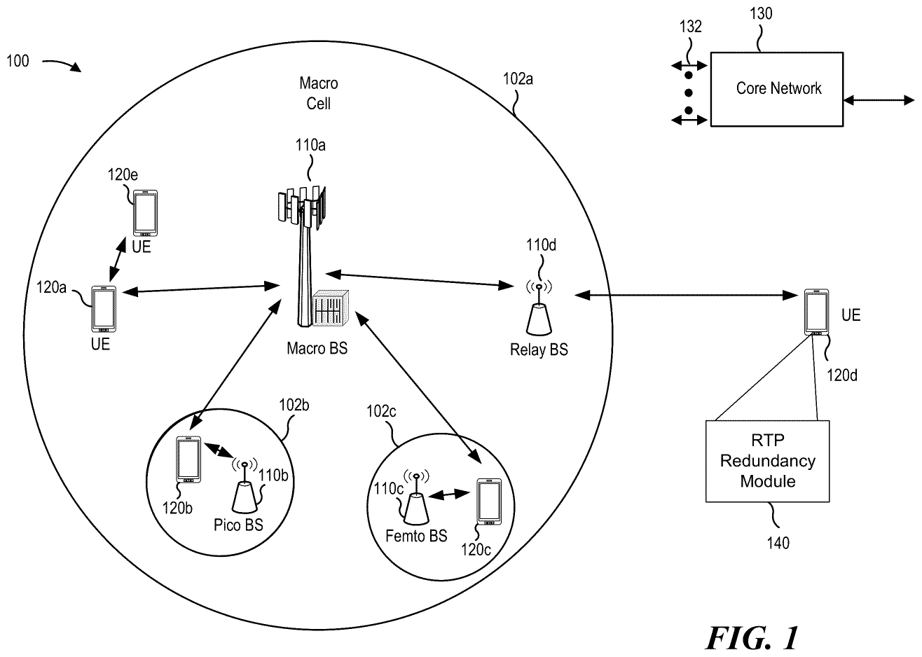

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a real-time transport protocol (RTP) redundancy module 140. For brevity, only one UE 120d is shown as including the RTP redundancy module 140. The RTP redundancy module 140 may establish a primary real-time transport protocol (RTP) link to a peer device via an Internet protocol-based multimedia subsystem (IMS) network. The RTP redundancy module 140 may establish a duplicate real-time transport protocol (RTP) link to the peer device via a firewall and a network address translation (NAT) server. The duplicate RTP link is initially established with a session traversal utilities for NAT (STUN) server. The RTP redundancy module 140 may transmit RTP packets to the peer device via the primary RTP link and the duplicate RTP link. The RTP redundancy module 140 may determine whether to continue with the duplicate RTP link established with the STUN server or to reestablish the duplicate RTP link with a traversal using relays around NAT (TURN) server.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

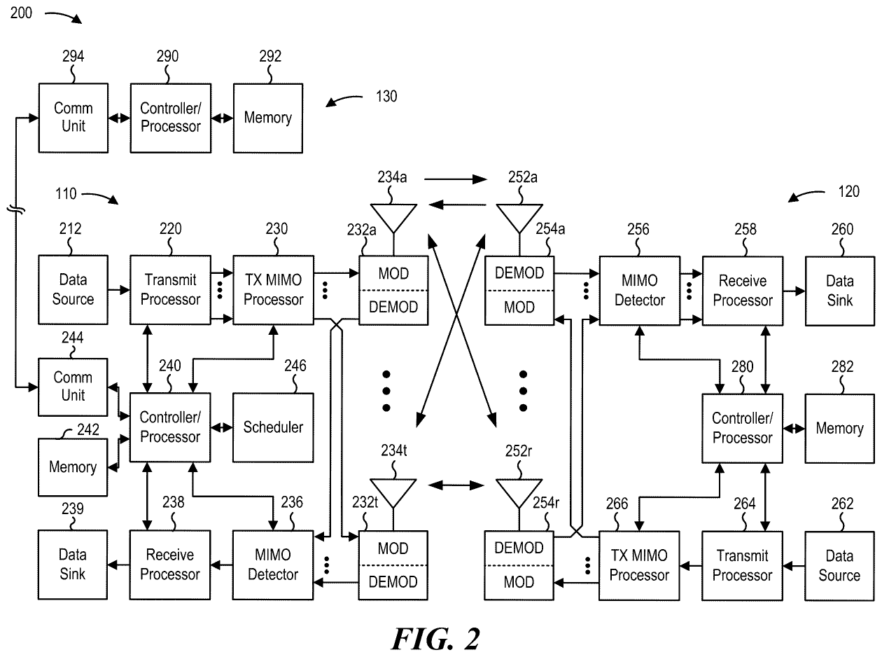

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T ≥1 and R ≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

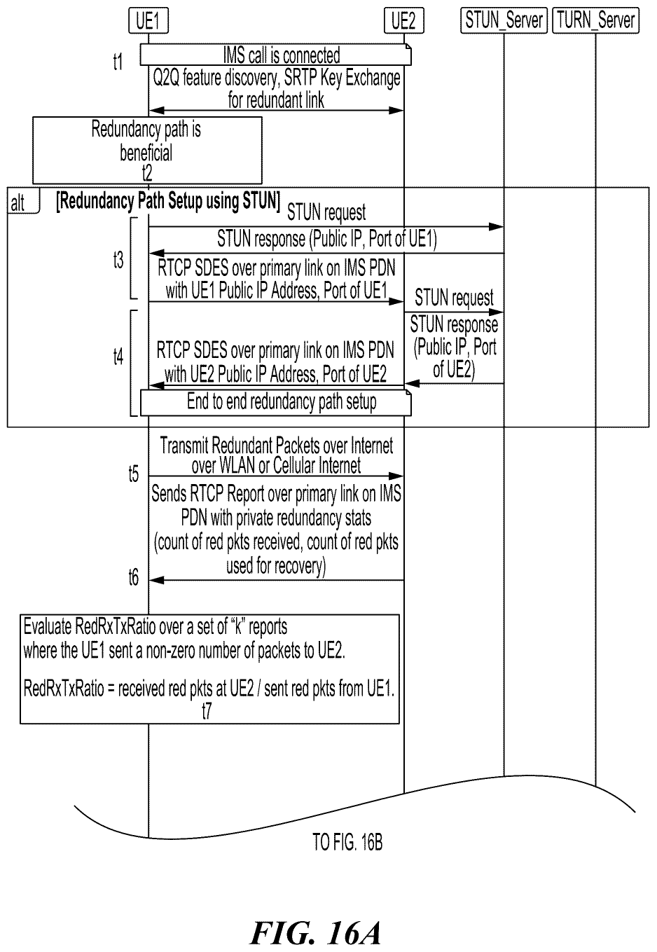

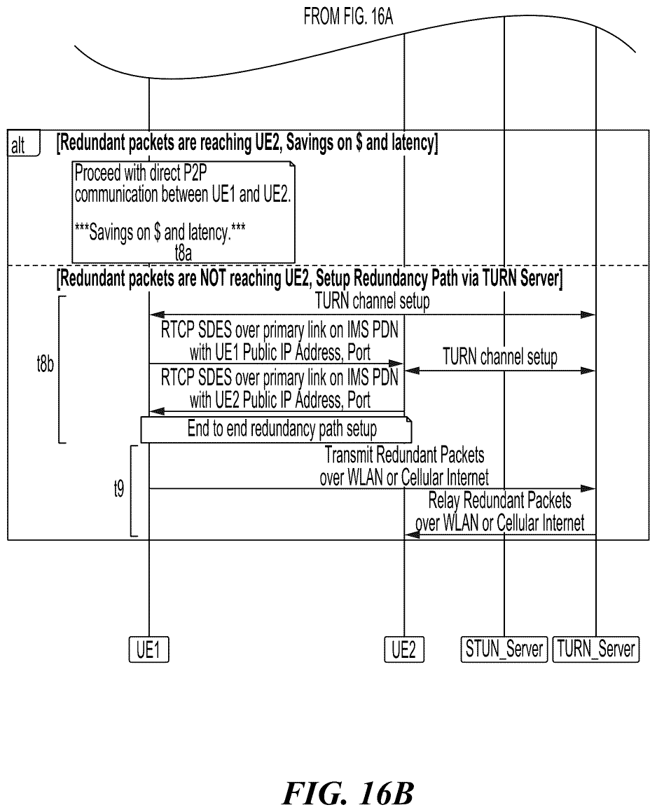

The controller/processor 240 of the base station 110, the controller/processor 280 of the UE 120, and/or any other component(s) of FIG. 2 may perform one or more techniques associated with RTP redundancy, as described in more detail elsewhere. For example, the controller/processor 240 of the base station 110, the controller/processor 280 of the UE 120, and/or any other component(s) of FIG. 2 may perform or direct operations of, for example, the processes of FIGS. 16-18 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for establishing, means for transmitting, means for determining, means for evaluating, means for continuing, means for reestablishing, means for repeating, and means for receiving. Such means may include one or more components of the UE 120 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

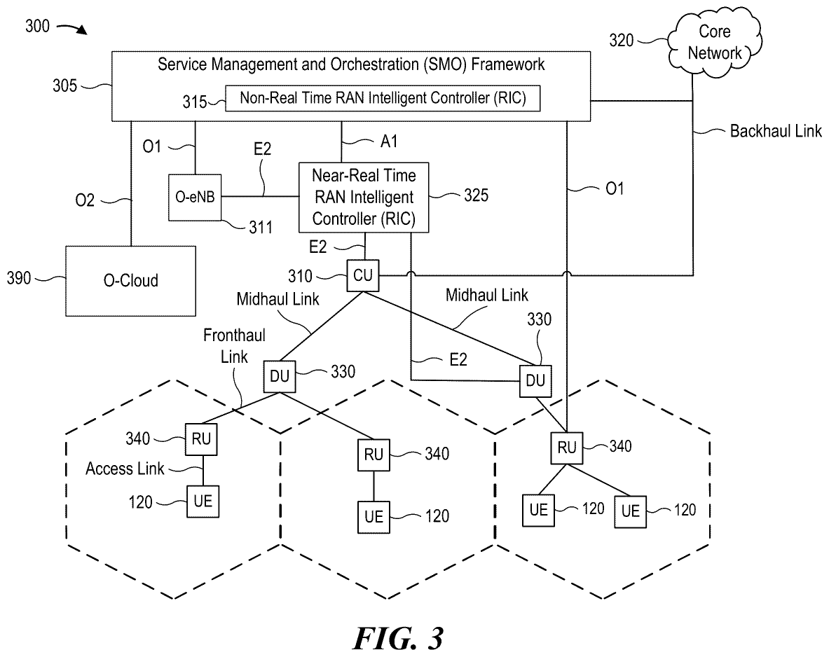

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT

RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

Real-time transport protocol (RTP) enables users to place audio and video calls over an Internet protocol (IP) network. Because a cellular network may provide poor connectivity, a wireless local area network (WLAN), such as WIFI, may be used to carry a secondary stream (also referred to as a duplicate or redundant stream/link). A receiver improves the quality of the transmitted voice and/or video data by receiving and merging the primary and duplicate streams.

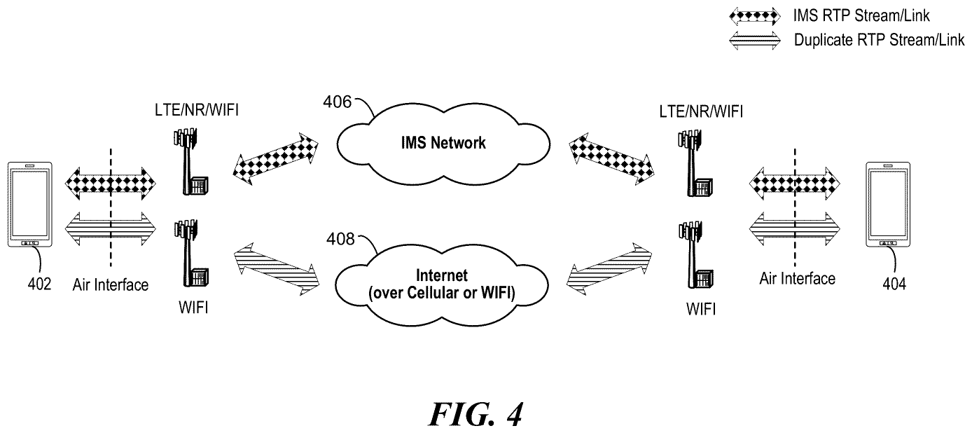

FIG. 4 is a diagram illustrating primary and duplicate RTP streams, in accordance with various aspects of the present disclosure. In the example of FIG. 4, a local UE 402 communicates with a remote UE 404. The local UE 402 places an Internet protocol (IP)-based multimedia subsystem (IMS) call to the remote UE 404 by establishing a primary IMS real-time transport protocol (RTP) link 406 via an IMS network. The local UE 402 also establishes a duplicate or redundant link 408 via a peer-to-peer (P2P) connection over the Internet. The redundant link 408 uses either WLAN or cellular Internet, for example. Either one UE or both UEs 402, 404 duplicate RTP packets are sent on the primary link 406 over to the redundant link 408. Because the redundant link 408 is over the Internet, network address translation (NAT) configurations and firewalls may block P2P communications. Thus, a traversal using relays around NAT (TURN) server may be employed to relay between UEs 402, 404 and penetrate the target UE's NAT interface and firewalls. TURN server usage comes with a pecuniary cost as the data is relayed, and also a latency cost for the packet flow. It would be desirable to control the TURN server usage and reduce the costs associated with using the TURN server.

Aspects of the present disclosure reduce the overall cost of the redundancy solution using a mix of session traversal utilities for NAT (STUN)-based and TURN-based redundancy. The proposed approach is a bandwidth efficient solution for VoIP redundancy using compact binary coded redundancy statistics data exchanged between devices leveraging an existing IMS packet data network (PDN) connection between UEs on a call.

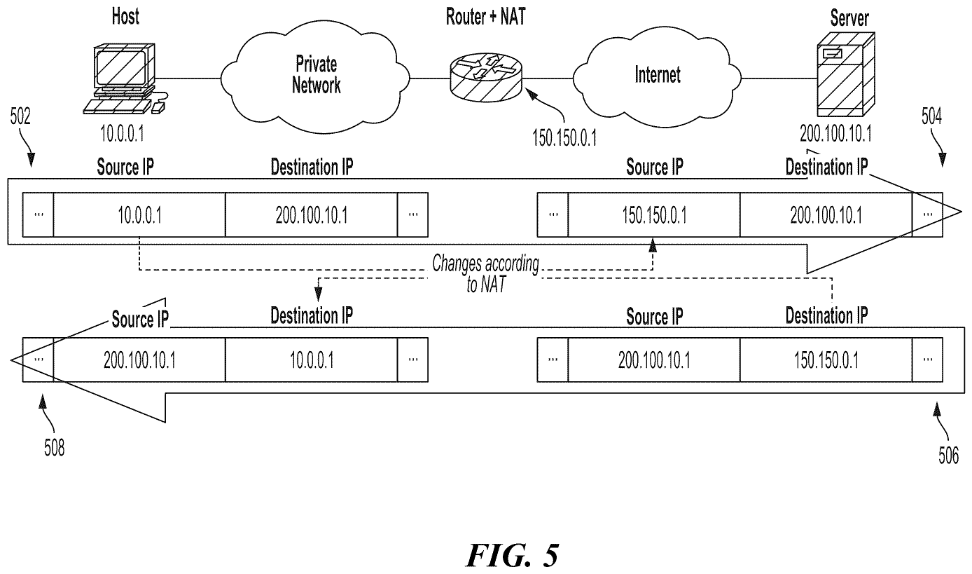

FIG. 5 is a diagram illustrating network address translation (NAT), in accordance with various aspects of the present disclosure. In the example of FIG. 5, a host device communicates with a server via a private network, a router and NAT, and the Internet. The NAT modifies network address information in IP packet headers while the packets are in transit, allowing multiple devices on a local network to share a single public IP address when accessing the Internet. In the example of FIG. 5, the host has a private IP address of 10.0.0.1 and the server has an IP address of 200.100.10.1. Thus, when the host sends a first packet 502 to the server, the source IP address is listed as 10.0.0.1 and the destination address is listed as 200.100.10.1, as seen in the first packet 502 prior to NAT in the router. The NAT converts the private source IP address to 150.150.0.1. Thus, a second packet 504 transmitted via the Internet to the server lists 150.150.0.1 as the source address in the packet header. When transmitting from the server to the host, a third packet 506 lists the destination IP address as 150.150.0.1 in the packet header. The NAT at the router converts the packet header to list the private IP address of the host (e.g., 10.0.0.1), as seen in a fourth packet 508.

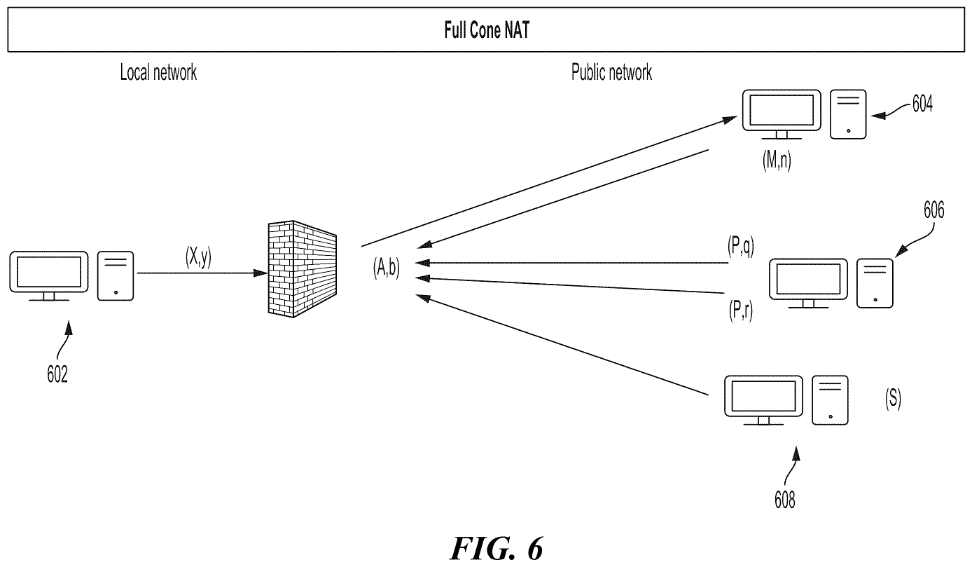

FIGS. 6-9 are diagrams illustrating various types of network address translation (NAT), in accordance with various aspects of the present disclosure. The figures show packet flow paths that are possible and not possible with different types of NAT. In the examples of FIGS. 6-9, the values (X, y) indicate a private IP address, and a private port of a source device 602 (e.g., the host of FIG. 5). The values (A, b) indicate a public IP address, and a public port of the source device 602 after NAT. The values (M, n), (P, q), and (P, r) are public IP addresses and ports of remote devices 604, 606. The value(S) is the public IP address of another remote device 608.

As seen in FIG. 6, once a port is opened, for example, between the source device 602 and the remote device 604, each remote device 604, 606, 608 may communicate with the source device 602. This configuration is referred to as full cone NAT.

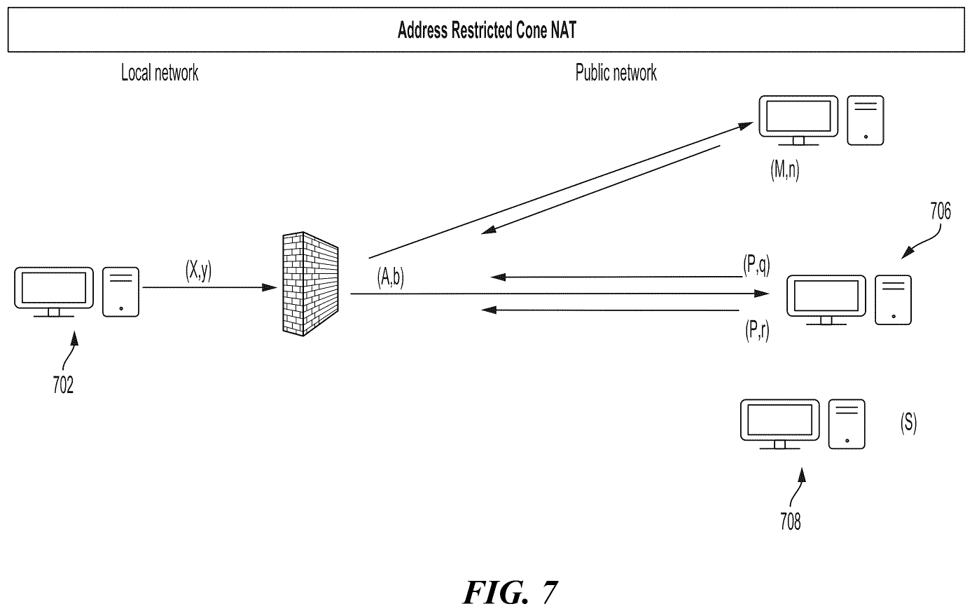

In the example of FIG. 7, address restricted cone NAT is shown. In this configuration, a remote device 708 is restricted from communicating with a source device 702 because the source device 702 has not opened an outbound connection to the remote device 708.

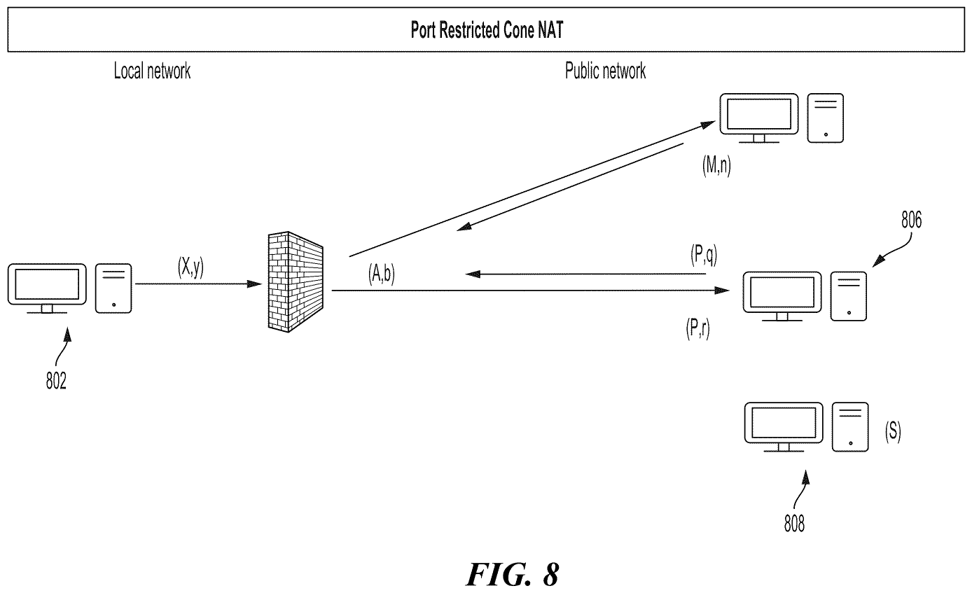

In the example of FIG. 8, port restricted cone NAT is shown. In this configuration, a remote device 808 is restricted from communicating with a source device 802 because the source device 802 has not opened an outbound connection to the remote device 808. Another application at a remote device 806 with the IP address and port combination (P, r) is also prevented from communicating with the source device 802 because a port (r) is different from a port (q) being used. That is, the source device 802 opened the port (q) with the remote device 806 but has not opened the port (r).

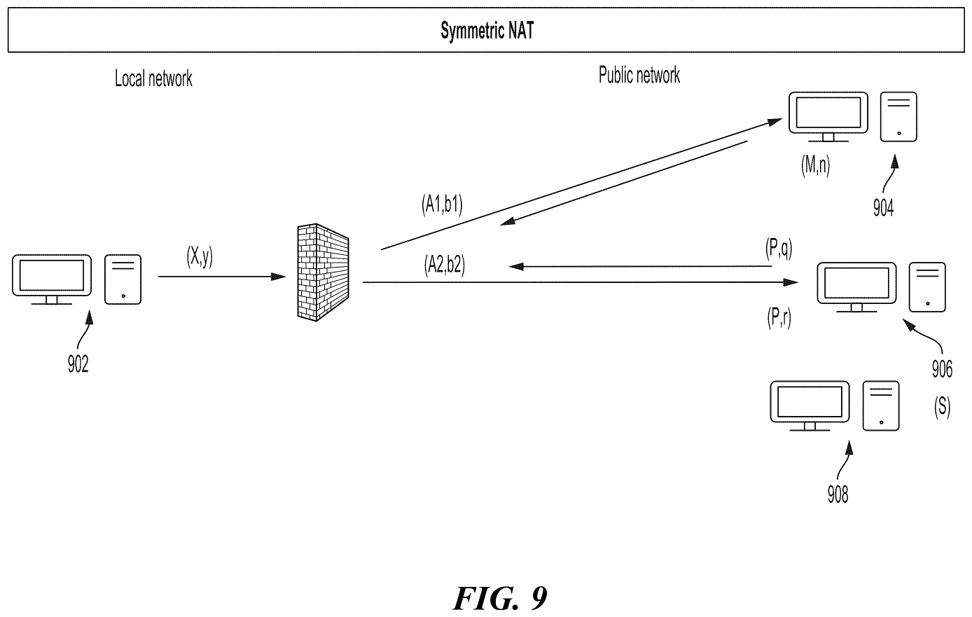

In the example of FIG. 9, symmetric NAT is shown. In this configuration, a remote device 908 is restricted from communicating with a source device 902 because one device cannot use another device's port. The source device 902 has not opened an outbound connection to the remote device 908. Another application at a remote device 906 with the IP address and port combination (P, r) is also prevented from communicating with the source device 902 because a port (r) is different from a port (q) being used. That is, the source device 902 opened the port (q) with the remote device 906 but has not opened the port (r). In this example, different public IP and port combinations (A1,b1 ), (A2,b2) are exposed for the same source device 902 but to different remote devices 904, 906 in the symmetric NAT configuration.

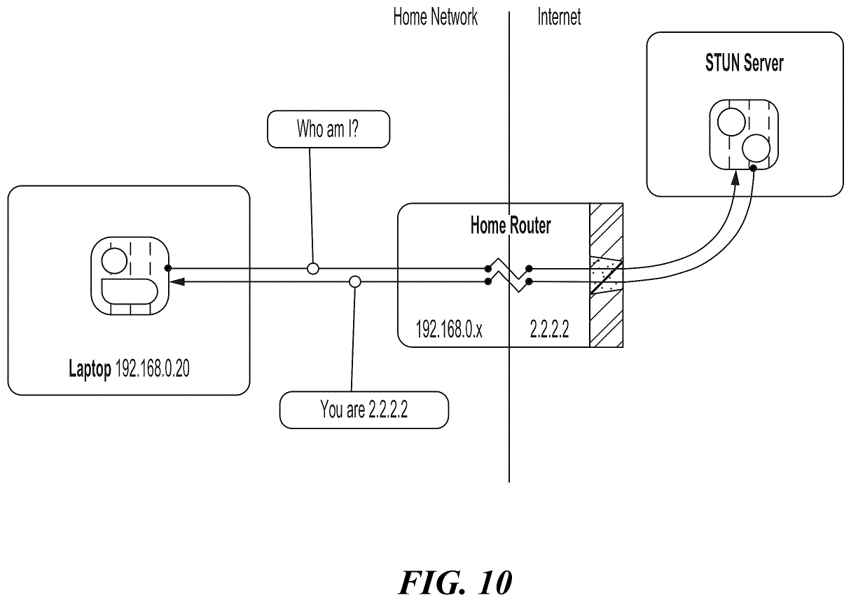

FIG. 10 is a diagram illustrating operation with a session traversal utilities for NAT (STUN) server, in accordance with various aspects of the present disclosure. A STUN server helps devices behind a NAT discover their public IP address and port number. In the example of FIG. 10, a source device (e.g., laptop) with private IP address 192.168.0.20 communicates with a STUN server via a router. The router translates the private IP address to 2.2.2.2. When the source device (e.g., laptop) transmits a request (e.g., who am I?) to the STUN server, the STUN server responds with the translated public IP address: “you are 2.2.2.2.” Although port information is not shown in FIG. 10, such information may also be provided by the STUN server.

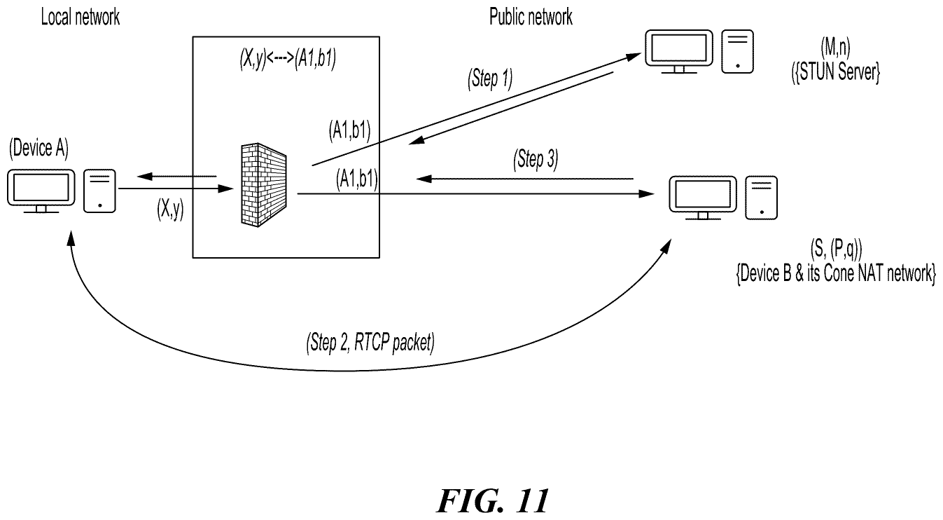

With a cone NAT configuration, peer-to-peer communications are possible using a STUN server. FIG. 11 is a block diagram illustrating peer-to-peer communications with a STUN server in a cone NAT configuration, in accordance with various aspects of the present disclosure. In the example of FIG. 11, initially a source device (device A) communicates with a STUN server at step 1. The STUN server session ends as soon as a response is sent to the source device (device A). At step 2, RTP control packets (RTCPs) may be communicated via a link opened during an IMS call. At step 3, a remote device (device B) opens a socket with the IP address and port combination (A1, b1 ) and is able to communicate with the source device (device A). The STUN server is lightweight, easy to maintain, and does not cause additional latency for real-time communication between peers. Because the remote device (device B) is able to communicate with the source device (device A), RTP duplication between the source device (device A) and the remote device (device B) is possible with a STUN server in a cone NAT configuration.

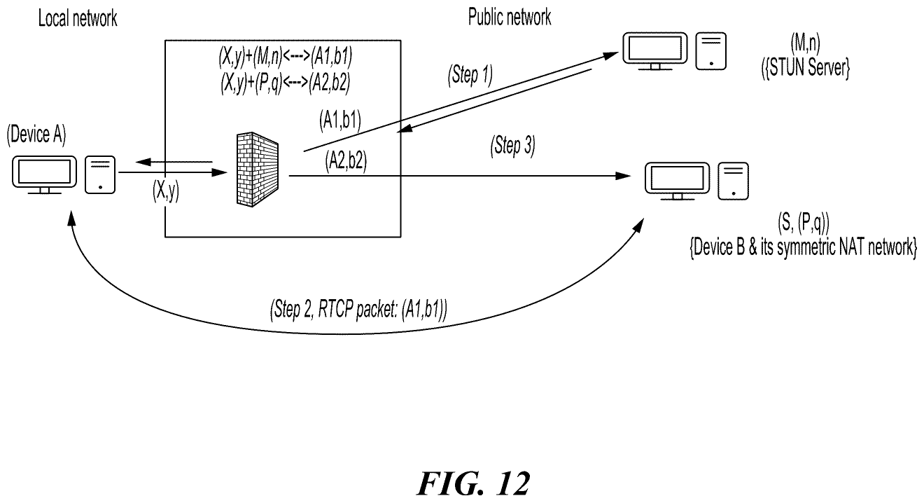

FIG. 12 is a block diagram illustrating peer-to-peer communications with a STUN server in a symmetric NAT configuration, in accordance with various aspects of the present disclosure. In the example of FIG. 12, initially a source device (device A) communicates with a STUN server at step 1. The STUN server session ends as soon as a response is sent to the source device (device A). The public IP address port combination is (A1,b1 ) for communications with the STUN server. At step 2, RTP control packets (RTCPs) may be communicated via a link opened during an IMS call. The public IP address port combination is (A1,b1) for the communications at step 2. At step 3, a remote device (device B) opens a socket with the IP address and port combination (A2, b2). With symmetric NAT, however, the public IP address and port of the source device (device A) that the STUN server sees is different from what the remote device (device B) sees, preventing RTP duplication between the source device (device A) and the remote device (device B) using the STUN server in the symmetric NAT configuration.

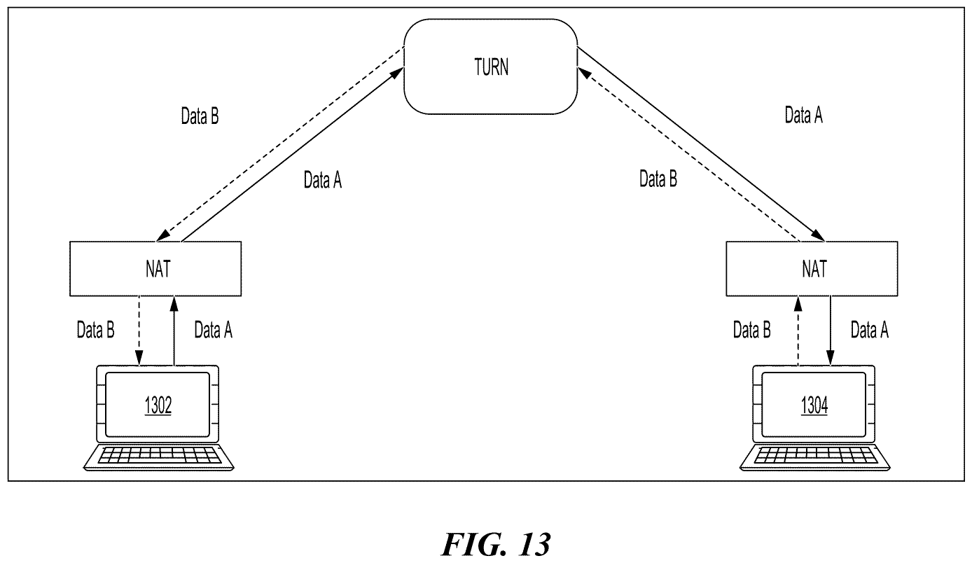

A TURN server helps devices communicate with each other when direct peer-to-peer (P2P) connections are not possible due to network restrictions, such as NAT configurations or firewalls. TURN servers act as intermediaries, relaying data between devices to ensure a stable connection. FIG. 13 is a diagram illustrating a

TURN server, in accordance with various aspects of the present disclosure. In the example of FIG. 13, the TURN server operates as a relay between a source device 1302 and a remote device 1304 to permit communications, even with NAT. Thus, the source device 1302 is able to transmit Data A to the remote device 1304, and the remote device 1304 is able to transmit Data B to the source device 1302.

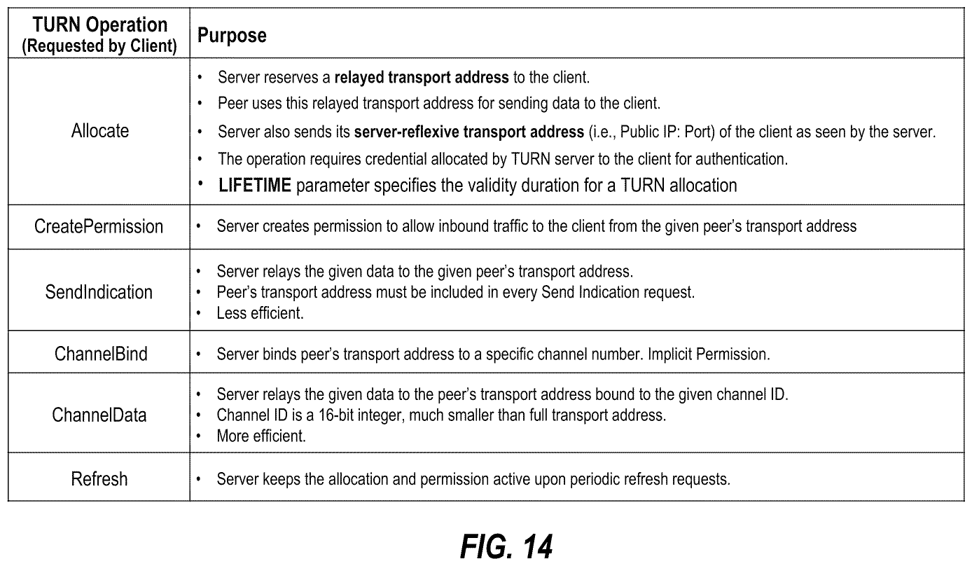

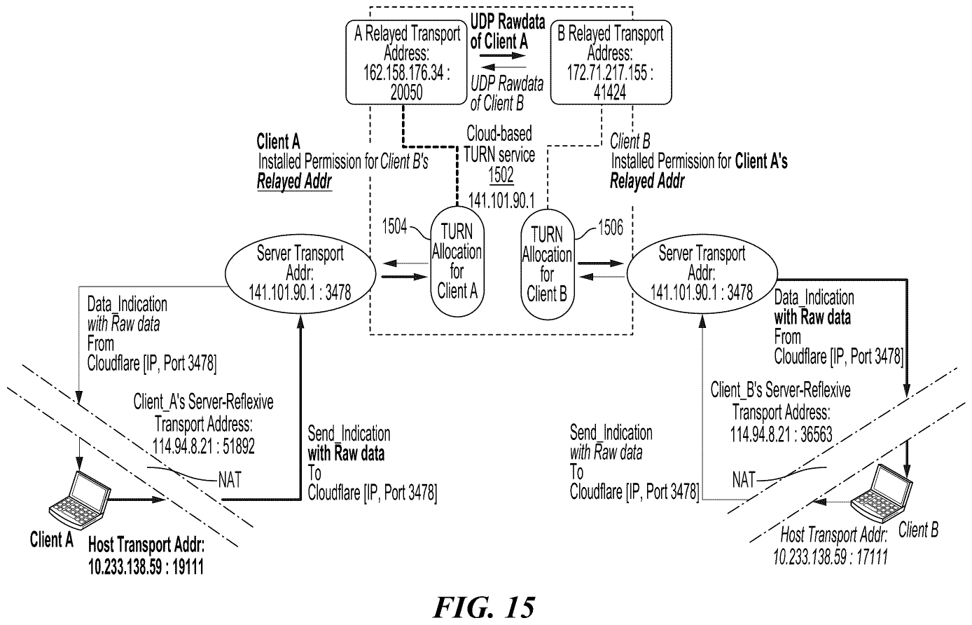

FIG. 14 is a table illustrating example operations of a TURN server. FIG. 15 is a diagram illustrating a dual TURN server configuration, in accordance with various aspects of the present disclosure. In the example of FIG. 15, Client A and Client B each send an Allocate message to a cloud-based TURN service 1502. The cloud-based TURN service 1502 allocates IP address 162.158.176.34 and port 20050 as a relayed transport addresses for Client A and IP address 172.71.217.111 and port 41424 as a relayed transport address for Client B. The relayed transport address is a public IP address installed at each peer's TURN server 1504, 1506 and is the destination address the other device uses. When Client A sends a packet with private IP address/port combination 10.233.138.59:19111, the NAT uses a server-reflexive transport address (114.94.8.21:51892) sent by the TURN server 1504.

In a setup with two separate TURN servers 1504, 1506, as seen in FIG. 15, when Client A sends data to Client B's relayed transport address, Client A's TURN server 1504 forwards the data to Client B's relayed address with a source address of the data changed to Client A's relayed address. Client B's TURN server 1506 accepts this data as the TURN server 1506 knows the destination (Client B's relay address) and the source (Client A's relay address) and forwards the data to Client B.

In the three types of non-symmetric cone NAT configurations described with respect to FIGS. 7-9, an internal address and port combination (e.g., iAddr:iPort) is mapped to an external address/port combination (eAddr:ePort). The external address/port combination (eAddr:ePort) is unique and consistent and is a one-to-one mapping. One internal address/port (iAddr:iPort) is only mapped to a unique and consistent external address (eAddr:ePort).

According to aspects of the present disclosure, a STUN server achieves peer-to-peer (P2P) communications inside such types of cone NAT networks. Referring back to FIGS. 7-9, the P2P transmissions includes:
Step 1: Device A 702, 802, 902 uses a STUN server to obtain a unique public IP address (e.g., (A, b) or (A1, b1 )).
Step 2: Device A 702, 802, 902 and device B 706, 806, 906 exchange public IP addresses through real-time control protocol (RTCP) packets. Device B 706, 806, 906 obtains device A's public IP address (A, b) or (A1,b1 ).
Step 3: Device B 706, 806, 906 sends packets to device A's public IP address/port (A, b) or (A1,b1 ). The address flow is from device B's public IP address and port (P, q) to device A's public IP address/port (A, b) or (A1,b1 ) to the private IP address and port of device A (X, y). The packet can reach device A 702, 802, 902, thus achieving P2P communications.

According to aspects of the present disclosure, with STUN/TURN-based P2P IMS media redundancy, each end shares its redundancy link statistics with the other end via real-time control protocol (RTCP) source description (SDES). STUN-based redundancy starts between user equipment (UEs) in the call. A quantity (k) of redundancy receive statistics/reports are received from the peer, where the quantity (k) can be as small as just one report from the peer. If the transmitter UE sees that the transmitter had sent redundant packets to the peer and the peer report states that the receiver had received zero redundant packets, then the UE(s) may be inside a symmetric network address translation (NAT) network. Thus, a TURN-based redundancy channel is established between the UEs. Otherwise, the STUN-based solution is acceptable, saving cost. Accordingly, a TURN server is not used for the call.

Another technique for selecting between STUN and TURN-based P2P IMS media redundancy is to query the sequence numbers (SNs) received by the peer on the redundant link using RTCP SDES sent over the primary link on the IMS packet data network (PDN). In these aspects, STUN-based redundancy is started between UEs in the call. The local UE sends an RTCP SDES query over the primary link to obtain a highest sequence number received by the peer on the redundant link. The remote UE sends an RTCP SDES response with the highest sequence number received on the redundant link. The procedure can be repeated k times for the local UE to ensure that the redundant link is working. If the STUN-based solution works, cost savings are achieved and additional latency is avoided. Otherwise, if the remote UE response repeatedly indicates an invalid sequence number (e.g., k times), then UEs may be inside a symmetric NAT network. Thus, a TURN-based redundancy channel is established between the UEs.

Although the current description is with respect to voice communications, video frames may also be sent over the redundancy link. Because video frames require significantly more bandwidth than audio frames, the cost saving is even more substantial for video communications.

FIGS. 16A and 16B show a call flow diagram illustrating STUN/TURN server determination, in accordance with various aspects of the present disclosure. At time t1, an IMS call is connected between a first UE (UE 1) and a second UE (UE 2). At time t2, UE 1 determines that a redundancy path would be beneficial. To set up the redundancy path, at time t3, UE 1 with address/port (X, y) sends packets to a STUN server at address (M, n) and receives a response from the STUN server. Based on the internal address (X, y) and the destination IP address and port, the symmetric NAT maps as address (A1, b1 ). This public IP address and port may only be used between UE 1 (X, y) and the STUN Server (M, n). At time t4, the public addresses are exchanged between UE 1 and UE 2 through RTCP packets. More specifically, UE 2 with address (P, q) obtains UE 1's public address (A1,b1), and also transmits a STUN request to the STUN server to obtain UE 2's address, which is forwarded to UE 1 via RTCP SDES.

At time t5, UE 1 transmits redundant packets to UE 2 over the Internet, WLAN, or cellular Internet. At time t6, UE 2 transmits an RTCP report to UE 1. At time t7, UE 1 evaluates whether the quantity of packets sent is the same number reported as received from UE 2. The evaluation maybe over a set quantity (k) of reports.

If the redundant packets are determined to be reaching UE 2 based on the report(s), then at time t8a, the direct P2P connection is maintained, saving costs and reducing latency. If the redundant packets are determined to NOT be reaching UE 2 based on the report(s), then at time t8b, the redundancy path is set up with a TURN server. More specifically, UE 1 communicates with the TURN server to establish a channel. Then, UE 1 transmits, to UE 2, the public address of UE 1 via RTCP SDES over the primary link. UE 2 then sets up a TURN channel and forwards to UE 1 the UE 2 public address via RTCP SDES over the primary link. After the appropriate end-to-end redundancy path is set up, at time t9, UE 1 transmits redundant packets to the TURN server, which relays the redundant packets to UE 2.

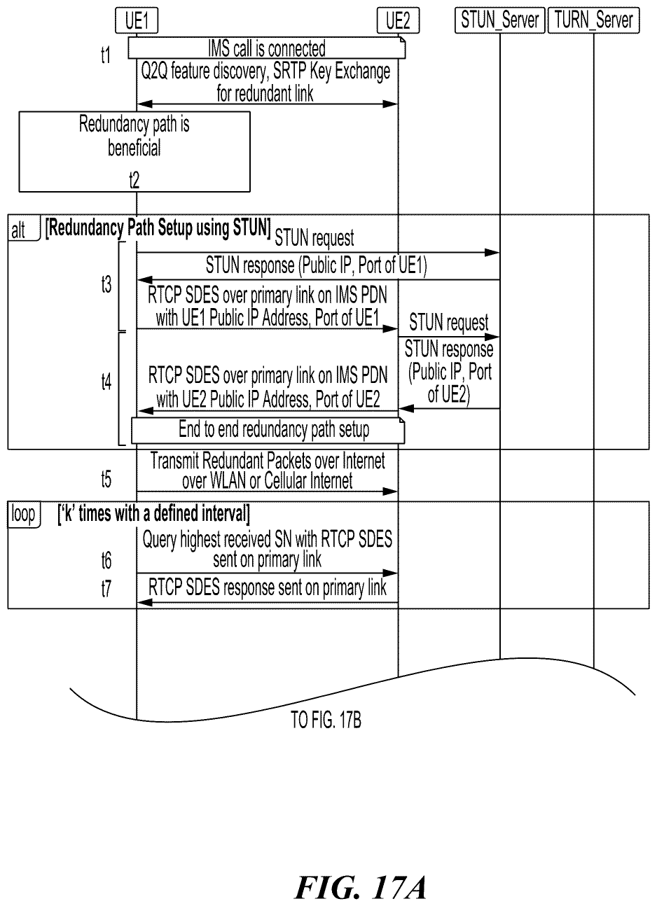

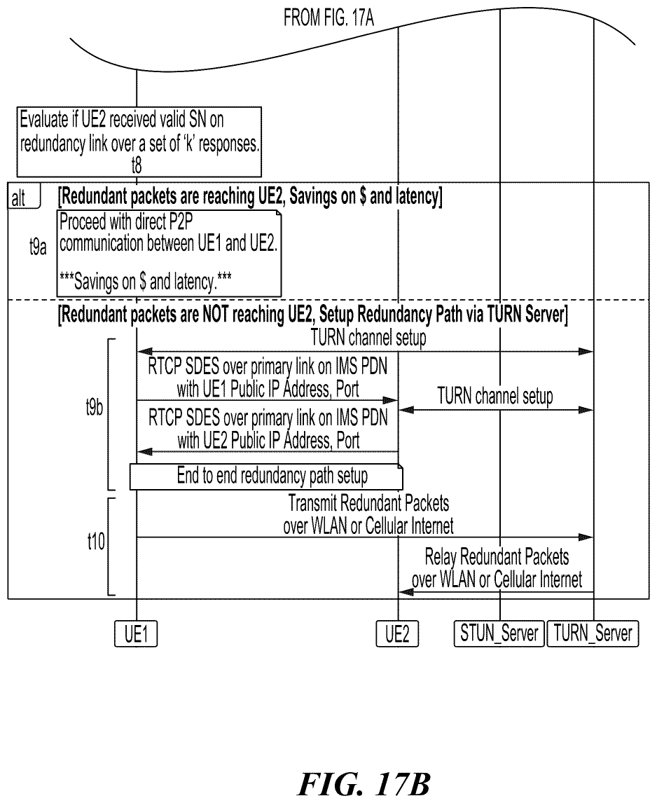

FIGS. 17A and 17B show a call flow diagram illustrating an alternative technique for STUN/TURN server determination, in accordance with various aspects of the present disclosure. At time t1, an IMS call is connected between a first UE (UE 1) and a second UE (UE 2). At time t2, UE 1 determines that a redundancy path would be beneficial. To set up the redundancy path, at time t3, UE 1 with address/port (X, y) sends packets to a STUN server at address (M, n) and receives a response from the STUN server. Based on the internal address (X, y) and the destination IP address and port, the symmetric NAT maps as address (A1,b1). This public IP address and port may only be used between UE 1 (X, y) and the STUN Server (M, n). At time t4, the public addresses are exchanged between UE 1 and UE 2 through RTCP packets. More specifically, UE 2 with address (P, q) obtains UE 1's public address (A1,b1 ), and also transmits a STUN request to the STUN server to obtain UE 2's address, which is forwarded to UE 1 via RTCP SDES.

At time t5, UE 1 transmits redundant packets to UE 2 over the Internet, WLAN, or cellular Internet. At time t6, UE 1 queries UE 2 for a highest sequence number of a received packet. The query is via RTCP SDES. At time t7, UE 2 transmits an RTCP report to UE 1 indicating the highest sequence number received on the redundant link. At time t8, UE 1 evaluates whether the sequence number reported is the same as the highest sequence number sent to UE 2. The evaluation may be over a set quantity (k) of reports.

If the sequence numbers match, indicating the packets are reaching UE 2 over the redundant link, then, at time t9a, the direct P2P connection is maintained, saving costs and reducing latency. If the redundant packets are determined to NOT be reaching UE 2 based on the report(s), then, at time t9b, the redundancy path is set up with a TURN server. More specifically, UE 1 communicates with the TURN server to establish a channel. Then, UE 1 transmits, to UE 2, the public address of UE 1 via RTCP SDES over the primary link. UE 2 then sets up a TURN channel and forwards to UE 1 the UE 2 public address via RTCP SDES over the primary link. After the appropriate end-to-end redundancy path is set up, at time t10, UE 1 transmits redundant packets to the TURN server, which relays the redundant packets to UE 2.

The techniques of the present disclosure allow lower latency, lower cost communications, based on NAT configurations.

As indicated above, FIGS. 3-17B are provided as examples. Other examples may differ from what is described with respect to FIGS. 3-17B.

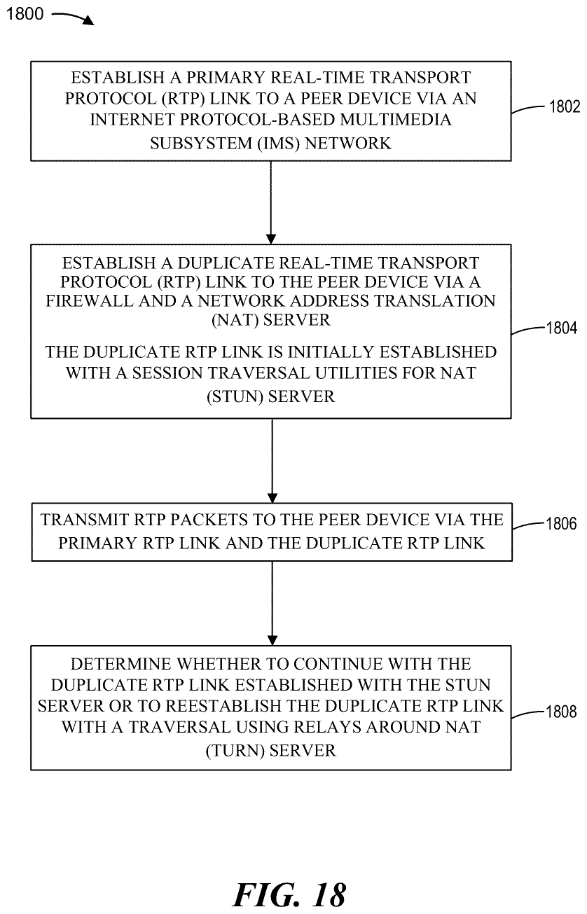

FIG. 18 is a flow diagram illustrating an example process 1800 performed, for example, by a user equipment (UE), in accordance with various aspects of the present disclosure. The example process 1800 is an example of bandwidth efficient and cost effective voice over Internet protocol (VoIP) transmit redundancy. The operations of the process 1800 may be implemented by a UE 120.

At block 1802, the user equipment (UE) establishes a primary real-time transport protocol (RTP) link to a peer device via an Internet protocol-based multimedia subsystem (IMS) network. For example, the UE (e.g., using the antenna 252, the DEMOD/MOD 254, TX MIMO processor 266, transmit processor 264, controller/processor 280, memory 282, and/or the like) may establish the primary RTP link. At block 1804, the user equipment (UE) establishes a duplicate real-time transport protocol (RTP) link to the peer device via a firewall and a network address translation (NAT) server. The duplicate RTP link is initially established with a session traversal utilities for NAT (STUN) server. For example, the UE (e.g., using the antenna 252, the DEMOD/MOD 254, TX MIMO processor 266, transmit processor 264, controller/processor 280, memory 282, and/or the like) may establish the duplicate RTP link.

At block 1806, the user equipment (UE) transmits RTP packets to the peer device via the primary RTP link and the duplicate RTP link. For example, the UE (e.g., using the antenna 252, the DEMOD/MOD 254, TX MIMO processor 266, transmit processor 264, controller/processor 280, memory 282, and/or the like) may transmit the RTP packets.

At block 1808, the user equipment (UE) determines whether to continue with the duplicate RTP link established with the STUN server or to reestablish the duplicate

RTP link with a traversal using relays around NAT (TURN) server. For example, the UE (e.g., using the controller/processor 280, memory 282, and/or the like) may determine whether to continue with the duplicate RTP link established with the STUN server or to reestablish the duplicate RTP link with a traversal using relays around NAT (TURN) server. In some aspects, the determining whether to continue includes evaluating whether RTP packets received at the peer device corresponds to a second quantity of RTP packets transmitted via the duplicate RTP link, continuing with the duplicate RTP link established with the STUN server in response to the first quantity of RTP packets corresponding to the second quantity of RTP packets, and reestablishing the duplicate RTP link with the TURN server, in response to the first quantity of RTP packets not corresponding to the second quantity of RTP packets. In other aspects, the determining includes evaluating whether a highest sequence number for an RTP packet received at the peer device corresponds to a current sequence number for a most recently sent RTP packet that was transmitted via the duplicate RTP link, continuing with the duplicate RTP link established with the STUN server in response to the highest sequence number corresponding to the current sequence number, and reestablishing the duplicate RTP link with the TURN server, in response to the highest sequence number not corresponding to the current sequence number.

### Example Aspects

Aspect 1: A method of wireless communication, comprising: establishing a primary real-time transport protocol (RTP) link to a peer device via an Internet protocol-based multimedia subsystem (IMS) network; establishing a duplicate real-time transport protocol (RTP) link to the peer device via a firewall and a network address translation (NAT) server, the duplicate RTP link initially established with a session traversal utilities for NAT (STUN) server; transmitting RTP packets to the peer device via the primary RTP link and the duplicate RTP link; and determining whether to continue with the duplicate RTP link established with the STUN server or to reestablish the duplicate RTP link with a traversal using relays around NAT (TURN) server.

Aspect 2: The method of Aspect 1, in which the determining comprises: evaluating whether a first quantity of RTP packets received at the peer device corresponds to a second quantity of RTP packets transmitted via the duplicate RTP link; continuing with the duplicate RTP link established with the STUN server in response to the first quantity of RTP packets corresponding to the second quantity of RTP packets; and reestablishing the duplicate RTP link with the TURN server, in response to the first quantity of RTP packets not corresponding to the second quantity of RTP packets.

Aspect 3: The method of Aspect 1 or 2, in which the evaluating occurs based on a predetermined quantity of reports received from the peer device, the reports indicating the first quantity of RTP packets.

Aspect 4: The method of Aspect 1, in which the determining comprises: evaluating whether a highest sequence number for an RTP packet received at the peer device corresponds to a current sequence number for a most recently sent RTP packet that was transmitted via the duplicate RTP link; continuing with the duplicate RTP link established with the STUN server in response to the highest sequence number corresponding to the current sequence number; and reestablishing the duplicate RTP link with the TURN server, in response to the highest sequence number not corresponding to the current sequence number.

Aspect 5: The method of any of the preceding Aspects 1 or 4, in which the evaluating comprises transmitting a query via the primary RTP link to obtain the highest sequence number from the peer device.

Aspect 6: The method of any of the preceding Aspects 1, 4, or 5, further comprising repeating the evaluating multiple times.

Aspect 7: The method of any of the preceding Aspects, in which the determining comprises receiving feedback via the primary RTP link.

Aspect 8: An apparatus for wireless communication, comprising: at least one memory; and at least one processor coupled to the at least one memory, the at least one processor configured: to establish a primary real-time transport protocol (RTP) link to a peer device via an Internet protocol-based multimedia subsystem (IMS) network; to establish a duplicate real-time transport protocol (RTP) link to the peer device via a firewall and a network address translation (NAT) server, the duplicate RTP link initially established with a session traversal utilities for NAT (STUN) server; to transmit RTP packets to the peer device via the primary RTP link and the duplicate RTP link; and to determine whether to continue with the duplicate RTP link established with the STUN server or to reestablish the duplicate RTP link with a traversal using relays around NAT (TURN) server.

Aspect 9: The apparatus of Aspect 8, in which the at least one processor is further configured: to evaluate whether a first quantity of RTP packets received at the peer device corresponds to a second quantity of RTP packets transmitted via the duplicate RTP link; to continue with the duplicate RTP link established with the STUN server in response to the first quantity of RTP packets corresponding to the second quantity of RTP packets; and to reestablish the duplicate RTP link with the TURN server, in response to the first quantity of RTP packets not corresponding to the second quantity of RTP packets.

Aspect 10: The apparatus of Aspect 8 or 9, in which the at least one processor is further configured to evaluate based on a predetermined quantity of reports received from the peer device, the reports indicating the first quantity of RTP packets.

Aspect 11: The apparatus of Aspect 8, in which the at least one processor is further configured: to evaluate whether a highest sequence number for an RTP packet received at the peer device corresponds to a current sequence number for a most recently sent RTP packet that was transmitted via the duplicate RTP link; to continue with the duplicate RTP link established with the STUN server in response to the highest sequence number corresponding to the current sequence number; and to reestablish the duplicate RTP link with the TURN server, in response to the highest sequence number not corresponding to the current sequence number.

Aspect 12: The apparatus of any of the Aspects 8 or 11, in which the at least one processor is further configured to transmit a query via the primary RTP link to obtain the highest sequence number from the peer device.

Aspect 13: The apparatus of any of the Aspects 8, 11 or 12, in which the at least one processor is further configured to repeat the evaluating multiple times.

Aspect 14: The apparatus of any of the Aspects 8-13, in which the at least one processor is further configured to receive feedback via the primary RTP link.

Aspect 15: A non-transitory computer-readable medium having program code recorded thereon, the program code executed by a processor and comprising: program code to establish a primary real-time transport protocol (RTP) link to a peer device via an Internet protocol-based multimedia subsystem (IMS) network; program code to establish a duplicate real-time transport protocol (RTP) link to the peer device via a firewall and a network address translation (NAT) server, the duplicate RTP link initially established with a session traversal utilities for NAT (STUN) server; program code to transmit RTP packets to the peer device via the primary RTP link and the duplicate RTP link; and program code to determine whether to continue with the duplicate RTP link established with the STUN server or to reestablish the duplicate RTP link with a traversal using relays around NAT (TURN) server.

Aspect 16: The non-transitory computer-readable medium of Aspect 15, in which the program code comprises: program code to evaluate whether a first quantity of RTP packets received at the peer device corresponds to a second quantity of RTP packets transmitted via the duplicate RTP link; program code to continue with the duplicate RTP link established with the STUN server in response to the first quantity of RTP packets corresponding to the second quantity of RTP packets; and program code to reestablish the duplicate RTP link with the TURN server, in response to the first quantity of RTP packets not corresponding to the second quantity of RTP packets.

Aspect 17: The non-transitory computer-readable medium of Aspect 15 or 16, in which the program code to evaluate is based on a predetermined quantity of reports received from the peer device, the reports indicating the first quantity of RTP packets.

Aspect 18: The non-transitory computer-readable medium of Aspect 15, in which the program code comprises: program code to evaluate whether a highest sequence number for an RTP packet received at the peer device corresponds to a current sequence number for a most recently sent RTP packet that was transmitted via the duplicate RTP link; program code to continue with the duplicate RTP link established with the STUN server in response to the highest sequence number corresponding to the current sequence number; and program code to reestablish the duplicate RTP link with the TURN server, in response to the highest sequence number not corresponding to the current sequence number.

Aspect 19: The non-transitory computer-readable medium of any of the Aspects 15 or 18, in which the program code comprises program code to transmit a query via the primary RTP link to obtain the highest sequence number from the peer device.

Aspect 20: The non-transitory computer-readable medium of any of the Aspects 15, 18, or 19, in which the program code comprises program code to repeat the evaluating multiple times.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication, comprising:
establishing a primary real-time transport protocol (RTP) link to a peer device via an Internet protocol-based multimedia subsystem (IMS) network;
establishing a duplicate real-time transport protocol (RTP) link to the peer device via a firewall and a network address translation (NAT) server, the duplicate RTP link initially established with a session traversal utilities for NAT (STUN) server;
transmitting RTP packets to the peer device via the primary RTP link and the duplicate RTP link; and
determining whether to continue with the duplicate RTP link established with the STUN server or to reestablish the duplicate RTP link with a traversal using relays around NAT (TURN) server.

2. The method of claim 1, in which the determining comprises:
evaluating whether a first quantity of RTP packets received at the peer device corresponds to a second quantity of RTP packets transmitted via the duplicate RTP link;
continuing with the duplicate RTP link established with the STUN server in response to the first quantity of RTP packets corresponding to the second quantity of RTP packets; and
reestablishing the duplicate RTP link with the TURN server, in response to the first quantity of RTP packets not corresponding to the second quantity of RTP packets.

3. The method of claim 2, in which the evaluating occurs based on a predetermined quantity of reports received from the peer device, the reports indicating the first quantity of RTP packets.

4. The method of claim 1, in which the determining comprises:
evaluating whether a highest sequence number for an RTP packet received at the peer device corresponds to a current sequence number for a most recently sent RTP packet that was transmitted via the duplicate RTP link;
continuing with the duplicate RTP link established with the STUN server in response to the highest sequence number corresponding to the current sequence number; and
reestablishing the duplicate RTP link with the TURN server, in response to the highest sequence number not corresponding to the current sequence number.

5. The method of claim 4, in which the evaluating comprises transmitting a query via the primary RTP link to obtain the highest sequence number from the peer device.

6. The method of claim 4, further comprising repeating the evaluating multiple times.

7. The method of claim 1, in which the determining comprises receiving feedback via the primary RTP link.

8. An apparatus for wireless communication, comprising:
at least one memory; and
at least one processor coupled to the at least one memory, the at least one processor configured:
to establish a primary real-time transport protocol (RTP) link to a peer device via an Internet protocol-based multimedia subsystem (IMS) network;
to establish a duplicate real-time transport protocol (RTP) link to the peer device via a firewall and a network address translation (NAT) server, the duplicate RTP link initially established with a session traversal utilities for NAT (STUN) server;
to transmit RTP packets to the peer device via the primary RTP link and the duplicate RTP link; and
to determine whether to continue with the duplicate RTP link established with the STUN server or to reestablish the duplicate RTP link with a traversal using relays around NAT (TURN) server.

9. The apparatus of claim 8, in which the at least one processor is further configured:
to evaluate whether a first quantity of RTP packets received at the peer device corresponds to a second quantity of RTP packets transmitted via the duplicate RTP link;
to continue with the duplicate RTP link established with the STUN server in response to the first quantity of RTP packets corresponding to the second quantity of RTP packets; and
to reestablish the duplicate RTP link with the TURN server, in response to the first quantity of RTP packets not corresponding to the second quantity of RTP packets.

10. The apparatus of claim 9, in which the at least one processor is further configured to evaluate based on a predetermined quantity of reports received from the peer device, the reports indicating the first quantity of RTP packets.

11. The apparatus of claim 8, in which the at least one processor is further configured:
to evaluate whether a highest sequence number for an RTP packet received at the peer device corresponds to a current sequence number for a most recently sent RTP packet that was transmitted via the duplicate RTP link;
to continue with the duplicate RTP link established with the STUN server in response to the highest sequence number corresponding to the current sequence number; and
to reestablish the duplicate RTP link with the TURN server, in response to the highest sequence number not corresponding to the current sequence number.

12. The apparatus of claim 11, in which the at least one processor is further configured to transmit a query via the primary RTP link to obtain the highest sequence number from the peer device.

13. The apparatus of claim 11, in which the at least one processor is further configured to repeat the evaluating multiple times.

14. The apparatus of claim 8, in which the at least one processor is further configured to receive feedback via the primary RTP link.

15. A non-transitory computer-readable medium having program code recorded thereon, the program code executed by a processor and comprising:
program code to establish a primary real-time transport protocol (RTP) link to a peer device via an Internet protocol-based multimedia subsystem (IMS) network;
program code to establish a duplicate real-time transport protocol (RTP) link to the peer device via a firewall and a network address translation (NAT) server, the duplicate RTP link initially established with a session traversal utilities for NAT (STUN) server;
program code to transmit RTP packets to the peer device via the primary RTP link and the duplicate RTP link; and
program code to determine whether to continue with the duplicate RTP link established with the STUN server or to reestablish the duplicate RTP link with a traversal using relays around NAT (TURN) server.

16. The non-transitory computer-readable medium of claim 15, in which the program code comprises:
program code to evaluate whether a first quantity of RTP packets received at the peer device corresponds to a second quantity of RTP packets transmitted via the duplicate RTP link;
program code to continue with the duplicate RTP link established with the STUN server in response to the first quantity of RTP packets corresponding to the second quantity of RTP packets; and
program code to reestablish the duplicate RTP link with the TURN server, in response to the first quantity of RTP packets not corresponding to the second quantity of RTP packets.

17. The non-transitory computer-readable medium of claim 16, in which the program code to evaluate is based on a predetermined quantity of reports received from the peer device, the reports indicating the first quantity of RTP packets.

18. The non-transitory computer-readable medium of claim 15, in which the program code comprises:
program code to evaluate whether a highest sequence number for an RTP packet received at the peer device corresponds to a current sequence number for a most recently sent RTP packet that was transmitted via the duplicate RTP link;
program code to continue with the duplicate RTP link established with the STUN server in response to the highest sequence number corresponding to the current sequence number; and
program code to reestablish the duplicate RTP link with the TURN server, in response to the highest sequence number not corresponding to the current sequence number.

19. The non-transitory computer-readable medium of claim 18, in which the program code comprises program code to transmit a query via the primary RTP link to obtain the highest sequence number from the peer device.

20. The non-transitory computer-readable medium of claim 18, in which the program code comprises program code to repeat the evaluating multiple times.
